(19) United States
(12) Patent Application Publication
(10) Pub. No.: US 2026/0325991 A1
(43) Pub. Date: Oct. 22, 2026

(54) ULTRASONIC-ELECTRIC FIELD COUPLED DEMULSIFICATION METHOD, MODULE, AND SEPARATION APPARATUS

(71) Applicant: CHINA UNIVERSITY OF PETROLEUM (EAST CHINA), Qingdao (CN)

(72) Inventors: Xiaoming LUO, Qingdao (CN); Wanrui LI, Qingdao (CN); Xueyan LI, Qingdao (CN); Donghai YANG, Qingdao (CN); Yuling LV, Qingdao (CN)

(21) Appl. No.: 19/653,222

(22) Filed: Apr. 21, 2026

(30) Foreign Application Priority Data
Apr. 21, 2025 (CN) 2025104994758

(51) Int. Cl. B01D 17/04; B01D 17/06; B06B 1/02; C02F 1/36; C02F 1/40; C02F 1/48; C02F 101/32; C02F 103/10; C10G 33/02; C10G 33/06

(52) U.S. Cl. CPC B01D 17/04; B01D 17/06; B06B 1/0292; C02F 1/36; C02F 1/40; C02F 1/48; C10G 33/02; C10G 33/06; C02F 2101/32; C02F 2103/10; C10G 2300/1033

(57) ABSTRACT

Disclosed is an ultrasonic-electric field coupled demulsification method, module, and separation apparatus in the technical field of separation methods in oil production, the method including: applying both an ultrasonic field and an electric field to a to-be-treated emulsion within the same region; performing synergistic demulsification on the emulsion using an ultrasonic cavitation effect and an electric field polarization effect, or performing synergistic demulsification on the emulsion using an ultrasonic mechanical effect and an electric field polarization effect; and performing oil-water separation on the demulsified emulsion. This disclosure improves the demulsification efficiency of the emulsion. The apparatus of this disclosure allows the ultrasonic-electric field coupled demulsification module to be arranged according to cross-sectional characteristics of the separation apparatus, and enables adjustment of ultrasonic parameters and electric field parameters according to characteristics of emulsions in different cross-sectional regions.

### CROSS-REFERENCE TO RELATED APPLICATIONS

This disclosure claims priority to Chinese Patent Application No. 202510499475.8, filed with the China National Intellectual Property Administration on Apr. 21, 2025 and titled “ULTRASONIC-ELECTRIC FIELD COUPLED DEMULSIFICATION METHOD, MODULE, AND SEPARATION APPARATUS”, which is incorporated herein by reference in its entirety and constitutes an integral part of this disclosure for all purposes.

### TECHNICAL FIELD

This disclosure relates to the technical field of separation methods in oil production and, in particular, to an ultrasonic-electric field coupled demulsification method, module, and separation apparatus.

### BACKGROUND

During the oil extraction process, surfactants, polymers, and other oil-displacing agents are often added to enhance the ability of the displacement fluid to strip and transport oil, thereby improving the recovery factor of crude oil. However, while these oil-displacing agents improve the recovery factor, they also significantly enhance the emulsion stability of the produced fluid, making oil-water separation more difficult. Existing demulsification methods mainly include thermochemical demulsification, electric demulsification, and ultrasonic demulsification, among which the electric demulsification method primarily uses an electric field polarization effect to induce inductive charges on water droplets, enhance collision and coalescence of water droplets, and accelerate the demulsification process. The ultrasonic demulsification method mainly relies on the cavitation effect and thermal effect of an ultrasonic wave. The cavitation effect generates oscillating microbubbles at a water droplet interface to promote synergistic oscillation of water droplets and weaken the strength of the interfacial film. The thermal effect can reduce the viscosity of the emulsion, lower the resistance to migration of water droplets, and facilitate collision and coalescence of water droplets.

However, existing demulsification technologies based on a single principle, such as thermochemical, electrostatic, and ultrasonic demulsification, all have certain limitations and are difficult to achieve efficient treatment of complex produced fluids. In addition, there are apparatuses that combine electrostatic technology and ultrasonic technology for demulsification. For example, Chinese patent CN115838605A discloses an array-type ultrasonic demulsification electro-desalination and dehydration apparatus, which enhances dehydration efficiency by arranging an ultrasonic transducer array below electrode plates. Nevertheless, this apparatus essentially represents a series configuration of ultrasonic demulsification and electrostatic demulsification, which can improve demulsification efficiency to some extent but still falls short of meeting the requirements of efficient oil-water separation. Therefore, neither the individual action nor the sequential action of ultrasonic demulsification and electrostatic demulsification can achieve efficient demulsification of complex produced fluids.

### SUMMARY

In view of the problems existing in the prior art, this disclosure provides an ultrasonic-electric field coupled demulsification method, module, and separation apparatus. The method promotes rapid coalescence of dispersed water droplets in oil through a synergistic action of an ultrasonic cavitation effect, an ultrasonic mechanical effect, and an electric field polarization effect, thereby improving the demulsification efficiency of emulsions. Meanwhile, the apparatus of this disclosure allows the ultrasonic-electric field coupled demulsification module to be arranged according to cross-sectional characteristics of the separation apparatus, and enables adjustment of ultrasonic parameters and electric field parameters according to characteristics of emulsions in different cross-sectional regions to optimize the demulsification effect.

The technical solutions of this disclosure are as follows:
in a first aspect of this disclosure, an ultrasonic-electric field coupled demulsification method is provided, including the following steps:
S1: applying both an ultrasonic field and an electric field to a to-be-treated emulsion within the same region;
S2: adjusting ultrasonic parameters to a range that generates a steady cavitation effect in the emulsion, while adjusting electric field parameters to a range that promotes effective electrocoalescence of water droplets in the emulsion, thereby performing synergistic demulsification on the emulsion using the ultrasonic cavitation effect and an electric field polarization effect;
or, adjusting ultrasonic parameters to a range that forms a standing wave field in the emulsion, while adjusting electric field parameters to a range that promotes effective electrocoalescence of water droplets in the emulsion, thereby performing synergistic demulsification on the emulsion using an ultrasonic mechanical effect and an electric field polarization effect; and
S3: performing oil-water separation on the emulsion demulsified in S2.

In some embodiments of this disclosure, the ultrasonic field and the electric field are arranged perpendicularly.

In a second aspect of this disclosure, an ultrasonic-electric field coupled demulsification module is provided, including at least one ultrasonic-electric field coupled demulsification unit, the unit including electrode plates, a transducer, an acoustic matching plate, an acoustic reflector plate, and a protective housing, where the electrode plates, the acoustic matching plate, and the acoustic reflector plate enclose a flow channel; the electrode plates are arranged in opposing pairs; the acoustic matching plate and the acoustic reflector plate are arranged opposite each other; the transducer is located outside the flow channel and installed on the acoustic matching plate; the protective housing is disposed outside the transducer; the electrode plates are configured to apply an electric field to an emulsion within the flow channel; the transducer is configured to apply an ultrasonic field to the emulsion within the flow channel; and the electric field and the ultrasonic field are used to perform synergistic demulsification on the emulsion within the flow channel.

In some embodiments of this disclosure, the electrode plates are arranged vertically opposite each other, and the acoustic matching plate and the acoustic reflector plate are arranged horizontally opposite each other.

In some embodiments of this disclosure, the electrode plates are arranged horizontally opposite each other, and the acoustic matching plate and the acoustic reflector plate are arranged vertically opposite each other.

In some embodiments of this disclosure, when an ultrasonic mechanical effect is used, a distance between the acoustic matching plate and the acoustic reflector plate is an integer multiple of half a wavelength of ultrasound in the emulsion.

In some embodiments of this disclosure, at least one transducer is installed on the acoustic matching plate, and the transducer can share the protective housing for protection.

In some embodiments of this disclosure, when a plurality of ultrasonic-electric field coupled demulsification units are arranged, adjacent ultrasonic-electric field coupled demulsification units can share the electrode plates, and the electrode plates are arranged in an alternating pattern of high-voltage electrode plates and low-voltage electrode plates.

In a third aspect of this disclosure, a separation apparatus is provided, where the ultrasonic-electric field coupled demulsification module is arranged in an emulsion layer region thereof according to cross-sectional characteristics of the separation apparatus, and a flow channel direction within the ultrasonic-electric field coupled demulsification module is consistent with a flow direction of an emulsion in the separation apparatus.

In some embodiments of this disclosure, the ultrasonic-electric field coupled demulsification module adjusts ultrasonic parameters and electric field parameters according to characteristics of emulsions in different cross-sectional regions of the separation apparatus.

One or more technical solutions of this disclosure have the following beneficial effects:
(1) the ultrasonic-electric field coupled demulsification method provided by this disclosure proposes using an ultrasonic cavitation effect and an electric field polarization effect for synergistic demulsification. During the synergistic demulsification process, both the cavitation effect and the polarization effect can reduce the strength of the interfacial film between water droplets, and their synergistic action can further reduce the strength of the interfacial film between water droplets, thereby facilitating the coalescence of water droplets. Alternatively, an ultrasonic mechanical effect and an electric field polarization effect are used for synergistic demulsification. During the synergistic demulsification process, the ultrasonic mechanical effect can promote the aggregation of dispersed water droplets to form water droplet bands, shortening the distance between water droplets, while the intensity of the electric field polarization effect is inversely proportional to the distance between water droplets. That is, the aggregation of dispersed water droplets by the ultrasonic mechanical effect enhances the electric field polarization effect, and the synergistic action of the two effects can achieve efficient coalescence of dispersed water droplet clusters.

Through the above demulsification method, the ultrasonic field and the electric field can achieve better coupling. Compared with the individual action of ultrasonic demulsification and electrostatic demulsification methods, as well as the sequential action of the two methods, this method comprehensively uses the ultrasonic cavitation effect, the ultrasonic mechanical effect, and the electric field polarization effect, and can significantly improve the demulsification efficiency of emulsions.
(2) Compared with thermochemical demulsification methods, the ultrasonic-electric field coupled demulsification method of this disclosure has significant advantages in terms of energy consumption and operating costs. Ultrasonic-electric field coupled demulsification greatly reduces the demulsification temperature and the consumption of chemical agents, thereby lowering overall energy consumption and operating costs. It has broad application prospects in the petrochemical industry.
(3) The ultrasonic-electric field coupled demulsification module proposed by this disclosure can be arranged according to the cross-sectional characteristics of the separation apparatus. This modular design not only improves the flexibility and adaptability of the apparatus but also facilitates apparatus installation and maintenance; the ultrasonic parameters and electric field parameters of different modules can be independently controlled according to the characteristics of emulsions at their respective locations to optimize the demulsification effect.

### BRIEF DESCRIPTION OF THE DRAWINGS

FIG. 1A is a diagram illustrating application of only an electric field wherein electrode plates are arranged vertically.

FIG. 1B is a diagram illustrating application of only an ultrasonic field wherein an acoustic matching plate and an acoustic reflector plate are arranged horizontally and ultrasonic parameters are controlled within a steady cavitation range.

FIG. 1C is a diagram illustrating a synergistic action of the ultrasonic field and the electric field, wherein the electrode plates are arranged vertically, the acoustic matching plate and the acoustic reflector plate are arranged horizontally and the ultrasonic parameters are controlled within the steady cavitation range.

FIG. 1D is a diagram illustrating application of only an electric field wherein electrode plates are arranged horizontally.

FIG. 1E is a diagram illustrating application of only an ultrasonic field wherein an acoustic matching plate and an acoustic reflector plate are arranged vertically and ultrasonic parameters are controlled within a steady cavitation range.

FIG. 1F is a diagram illustrating a synergistic action of the ultrasonic field and the electric field, wherein the electrode plates are arranged horizontally, the acoustic matching plate and the acoustic reflector plate are arranged vertically and the ultrasonic parameters are controlled within the steady cavitation range.

FIG. 1G is a diagram illustrating application of only an electric field wherein electrode plates are arranged vertically.

FIG. 1H is a diagram illustrating application of only an ultrasonic field wherein an acoustic matching plate and an acoustic reflector plate are arranged horizontally and ultrasonic parameters are controlled to form a standing wave field.

FIG. 1I is a diagram illustrating a synergistic action of an ultrasonic mechanical effect and an electric field polarization effect wherein the electrode plates are arranged vertically, the acoustic matching plate and the acoustic reflector plate are arranged horizontally and the ultrasonic parameters are controlled to form a standing wave field.

FIG. 1J is a diagram illustrating application of only an electric field wherein electrode plates are arranged horizontally.

FIG. 1K is a diagram illustrating application of only an ultrasonic field wherein an acoustic matching plate and an acoustic reflector plate are arranged vertically and ultrasonic parameters are controlled to form a standing wave field.

FIG. 1L is a diagram illustrating a synergistic action of an ultrasonic mechanical effect and an electric field polarization effect wherein the electrode plates are arranged horizontally, the acoustic matching plate and the acoustic reflector plate are arranged vertically and the ultrasonic parameters are controlled to form a standing wave field.

FIG. 2 is a first schematic structural diagram of an ultrasonic-electric field coupled demulsification unit according to Example 2 of this disclosure.

FIG. 3 is a second schematic structural diagram of the ultrasonic-electric field coupled demulsification unit according to Example 2 of this disclosure.

FIG. 4 is a schematic structural diagram of an ultrasonic-electric field coupled demulsification module corresponding to the ultrasonic-electric field coupled demulsification unit shown in FIG. 2.

FIG. 5 is a schematic structural diagram of an ultrasonic-electric field coupled demulsification module corresponding to the ultrasonic-electric field coupled demulsification unit shown in FIG. 3.

FIG. 6 is a schematic structural diagram of a separation apparatus according to Example 3 of this disclosure.

FIG. 7 is a schematic cross-sectional view taken along A-A after the ultrasonic-electric field coupled demulsification module shown in FIG. 4 is installed inside the separation apparatus shown in FIG. 6.

FIG. 8 is a schematic cross-sectional view taken along A-A after the ultrasonic-electric field coupled demulsification module shown in FIG. 5 is installed inside the separation apparatus shown in FIG. 6.

In the figures: 1, electrode plate; 2, transducer; 3, acoustic matching plate; 4, acoustic reflector plate; 5, protective housing; 6, separator inlet; 7, flow-straightening plate; 8, separator cylinder; 9, ultrasonic-electric field coupled demulsification module; 10, gas outlet; 11, weir plate; 12, water outlet; 13, oil outlet; 14, inlet distributor; 15, mist eliminator; 16, water layer; 17, emulsion layer; 18, oil layer.

### DETAILED DESCRIPTION

This disclosure will be further described with reference to the accompanying drawings and examples.

### EXAMPLE 1

The technical concept of this disclosure is as follows:

Electric field demulsification technology is widely used in oilfields due to its simplicity and efficiency; however, it is difficult to achieve efficient demulsification of complex produced fluids. Ultrasonic demulsification technology has a relatively complex demulsification mechanism, and the demulsification effect is difficult to control. Existing ultrasonic demulsification technologies mainly utilize the principle of ultrasonic cavitation effect for demulsification, but the inventors have noted that ultrasound not only has a cavitation effect but also has a mechanical effect induced by an ultrasonic standing wave field, and the combination of these two effects with an electric field polarization effect can achieve a good demulsification effect. The concept of this disclosure is proposed based on the study of the demulsification mechanisms of ultrasonic and electric fields, achieving ultrasonic-electric field coupled demulsification by defining ultrasonic parameters and electric field parameters.

For this purpose, a typical embodiment of this disclosure provides an ultrasonic-electric field coupled demulsification method, including the following steps:
S1: applying both an ultrasonic field and an electric field to a to-be-treated emulsion within the same region;
S2: adjusting ultrasonic parameters to a range that generates a steady cavitation effect in the emulsion, while adjusting electric field parameters to a range that promotes effective electrocoalescence of water droplets in the emulsion, thereby performing synergistic demulsification on the emulsion using the ultrasonic cavitation effect and an electric field polarization effect;
or, adjusting ultrasonic parameters to a range that forms a standing wave field in the emulsion, while adjusting electric field parameters to a range that promotes effective electrocoalescence of water droplets in the emulsion, thereby performing synergistic demulsification on the emulsion using an ultrasonic mechanical effect and an electric field polarization effect; and
S3: performing oil-water separation on the emulsion demulsified in S2.

When the ultrasonic cavitation effect and the electric field polarization effect are used to synergistically demulsify the emulsion, the ultrasonic steady cavitation effect generates periodically oscillating bubbles that cause water droplets to oscillate and weaken the stability of the interfacial film, while the oscillation of the water droplets accelerates the coalescence of adjacent water droplets; the electric field polarization effect enhances the oscillation of the water droplets to further reduce the strength of the interfacial film and promote directional migration and coalescence of the water droplets through electrophoresis and dielectrophoresis effects. The synergistic demulsification through the two effects significantly improves the coalescence efficiency of dispersed water droplets, thereby accelerating the demulsification process.

When the ultrasonic mechanical effect and the electric field polarization effect are used to synergistically demulsify the emulsion, under the action of the standing wave field, the ultrasonic mechanical effect drives dispersed water droplets to migrate toward pressure nodal regions, forming a band-like distribution of water droplets, shortening the distance between water droplets, and promoting coalescence of water droplets; the electric field polarization effect enhances the oscillation of the water droplets to reduce the strength of the interfacial film and promote directional migration and coalescence of the water droplets through electrophoresis and dielectrophoresis effects that are stronger at short distances. The synergistic demulsification through the two effects effectively improves the coalescence efficiency of dispersed water droplets, thereby accelerating the demulsification process.

In this example, the ultrasonic field and the electric field are arranged perpendicularly. Specifically, when the ultrasonic cavitation effect and the electric field polarization effect are used to synergistically demulsify the emulsion, the ultrasonic field and the electric field can be arranged arbitrarily as needed; when the ultrasonic mechanical effect and the electric field polarization effect are used to synergistically demulsify the emulsion, it is only necessary to ensure that the ultrasonic field and the electric field are not parallel, but the demulsification effect is optimal when the ultrasonic field and the electric field are arranged perpendicularly.

In this example, the range that generates a steady cavitation effect in the emulsion, the range that causes effective electrocoalescence of water droplets in the emulsion, and the range that forms a standing wave field in the emulsion are all obtained through experiments.

The cavitation effect generated by ultrasound generally occurs at relatively low ultrasonic frequencies. When parameters such as ultrasonic frequency remain constant, as the ultrasonic intensity (acoustic intensity) increases, the changes in cavitation bubbles become increasingly drastic. When the acoustic intensity parameter exceeds a transient cavitation threshold, the cavitation bubbles will collapse, causing high temperature and high pressure, shock waves, and micro-jets. Such effects can lead to secondary breakup of water droplets, thereby intensifying emulsification. Therefore, the acoustic intensity needs to be below the transient cavitation threshold. However, if the acoustic intensity is too low, the cavitation effect will not occur either. Thus, there exists a steady cavitation range, which is related to the physical properties of the emulsion and can be obtained through experimental measurement.

Generally, the greater the electric field strength, the stronger the electrophoresis and dielectrophoresis effects, and the faster the water droplets migrate closer, resulting in higher coalescence efficiency. However, in practice, the water droplets undergo charge exchange upon collision, which can convert the charge that originally drove attraction of water droplets into one that pulls the water droplets apart. This effect may exceed the capillary force between water droplets once the electric field strength reaches a certain threshold, thereby preventing coalescence of water droplets. At particularly high field strengths, individual water droplets may be disrupted by their own opposite charges, generating smaller water droplets and intensifying emulsification. Conversely, when the electric field strength is too low, the migration speed of the water droplets is slow, and the electrocoalescence efficiency is very low. Therefore, there exists an effective electrocoalescence range, which is related to the physical properties of the emulsion and can be obtained through experimental measurement.

When the distance between the incident and reflecting ends of an ultrasonic wave is an integer multiple of half the wavelength, an ultrasonic standing wave field will be formed. In the standing wave field, the ultrasonic mechanical effect drives dispersed water droplets to migrate toward pressure nodal regions, forming water droplet bands. Generally, the ultrasonic standing wave field is established at relatively high ultrasonic frequencies. If the ultrasonic frequency is too low, a cavitation effect occurs, interfering with the migration of water droplets. If the ultrasonic frequency is too high, the resulting excessively long wavelength may exceed the capacity of the experimental equipment. The migration efficiency of water droplets increases with increasing acoustic intensity; however, when the acoustic intensity is too high, acoustic streaming phenomena may occur, thereby disturbing and disrupting the water droplet bands. Therefore, the ultrasonic mechanical effect also has an efficient operating range, which is related to the physical properties of the emulsion and can be obtained through experimental measurement.

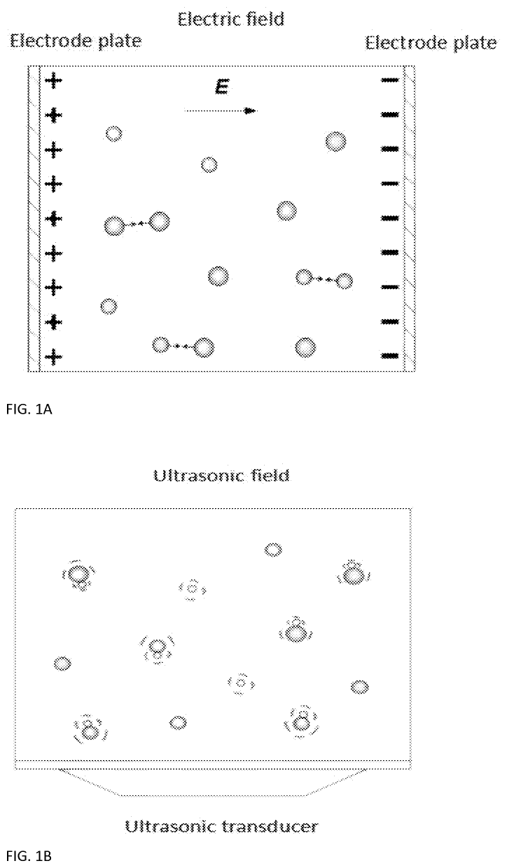

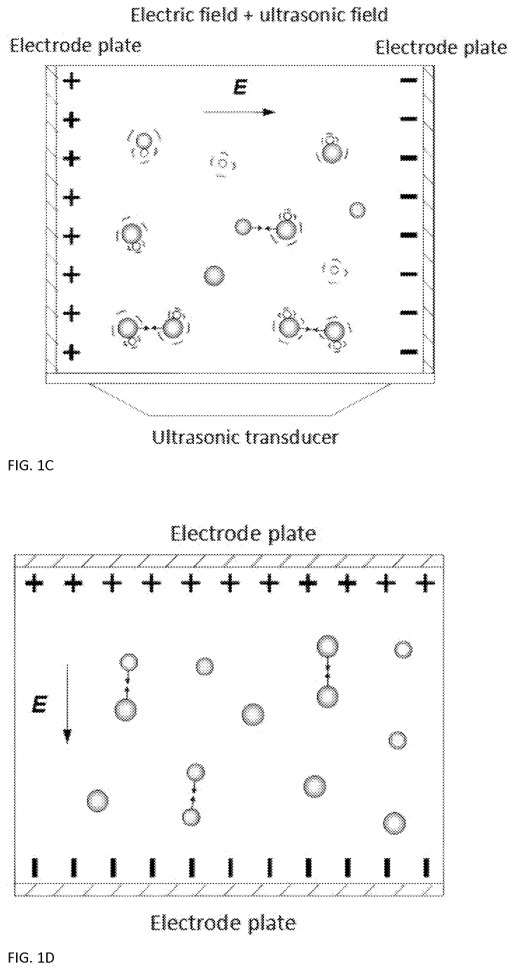

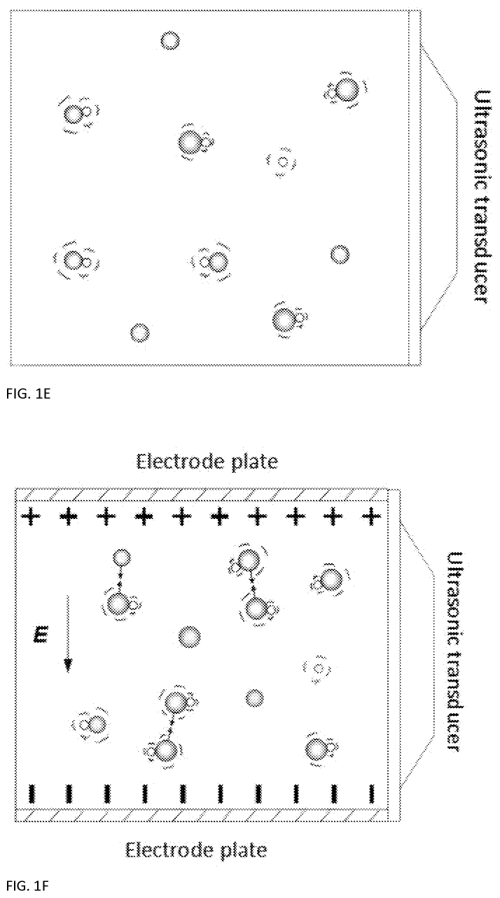

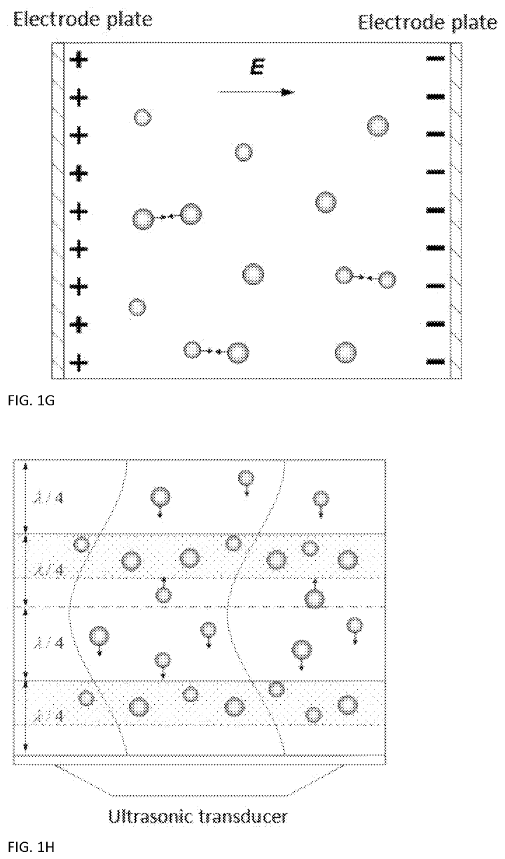

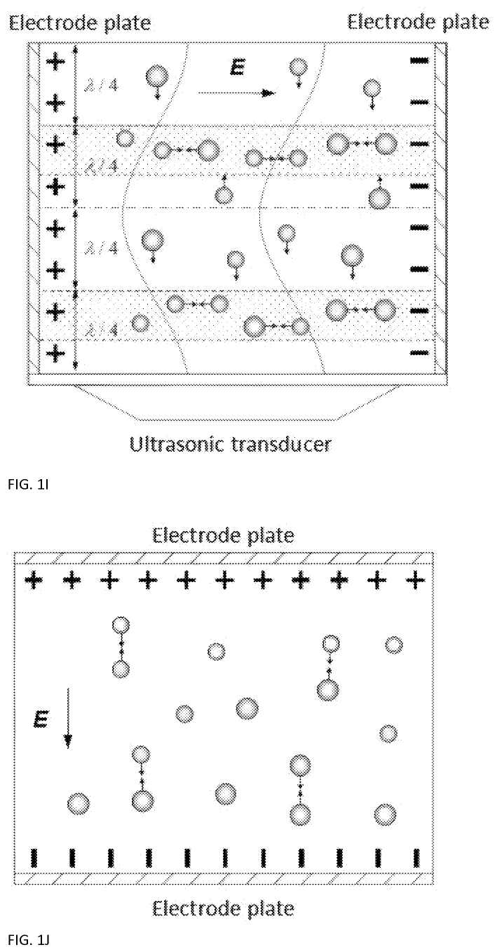

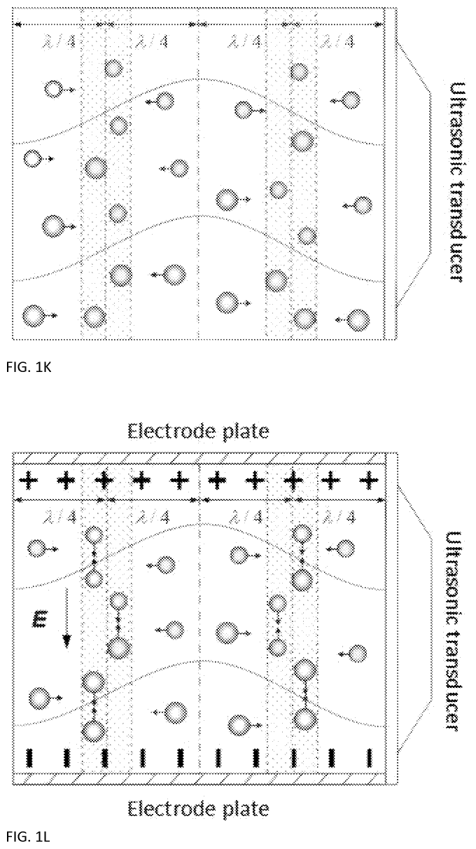

The principle of ultrasonic-electric field coupled demulsification of this example is compared with existing demulsification principles that apply only an electric field or only an ultrasonic effect, where FIG. 1A, FIG. 1D, FIG. 1G and FIG. 1J represent application of only an electric field; FIG. 1B, FIG. 1E, FIG. 1H and FIG. 1K represent application of only an ultrasonic field; and FIG. 1C, FIG. 1F, FIG. 1I and FIG. 1L represent a synergistic action of an ultrasonic field and an electric field, among which FIG. 1C and FIG. 1F represent a synergistic action of an ultrasonic cavitation effect and an electric field polarization effect; FIG. 1I and FIG. 1L represent a synergistic action of an ultrasonic mechanical effect and an electric field polarization effect. In FIG. 1C and FIG. 1I, the electrode plates are arranged vertically, and the acoustic matching plate and the acoustic reflector plate are arranged horizontally, i.e., the electric field direction is perpendicular to the gravitational field direction, and the ultrasonic field direction is parallel to the gravitational field direction. This arrangement is adopted in Embodiment 1 of this example. In FIG. 1F and FIG. 1L, the electrode plates are arranged horizontally, and the acoustic matching plate and the acoustic reflector plate are arranged vertically, i.e., the electric field direction is parallel to the gravitational field direction, and the ultrasonic field direction is perpendicular to the gravitational field direction. This arrangement is adopted in Embodiment 2 of this example.

The detailed analysis is as follows:
as shown in FIG. 1A, FIG. 1D, FIG. 1G, and FIG. 1J, when only an electric field is applied, the polarization effect induces inductive charges on water droplets, thereby causing oscillation and migration of the water droplets. High-frequency oscillation can weaken the strength of the interfacial film of water droplets, while electrophoresis and dielectrophoresis effects cause directional migration of water droplets, enhancing the collision and coalescence of water droplets, and accelerating the demulsification process.

As shown in FIG. 1B and FIG. 1E, when only an ultrasonic field is applied and the ultrasonic parameters are controlled within the steady cavitation range, the cavitation effect generates periodically oscillating tiny bubbles at a water droplet interface, promoting synergistic oscillation of water droplets and weakening the oil-water interfacial film, while the oscillation of water droplets also facilitates coalescence of adjacent water droplets.

As shown in FIG. 1H and FIG. 1K, when only an ultrasonic field is applied and the ultrasonic parameters are controlled to form a standing wave field, the ultrasonic mechanical effect drives dispersed water droplets to migrate toward pressure nodal regions, forming a band-like distribution of water droplets and promoting coalescence of water droplets, as indicated by the dark regions in FIG. 1H and FIG. 1K.

As shown in FIG. 1C and FIG. 1F, when an ultrasonic field and an electric field are applied simultaneously and the ultrasonic parameters are controlled within the steady cavitation range, the ultrasonic steady cavitation effect generates periodically oscillating bubbles that cause water droplets to oscillate and weaken the stability of the interfacial film, while the oscillation of the water droplets accelerates the coalescence of adjacent water droplets; the electric field polarization effect causes oscillation of water droplets to further reduce the strength of the interfacial film and promote directional migration and coalescence of water droplets through electrophoresis and dielectrophoresis effects. The synergistic action of the two effects effectively improves the coalescence efficiency of water droplets, thereby accelerating the demulsification process.

As shown in FIG. 1I and FIG. 1L, when an ultrasonic field and an electric field are applied simultaneously and the ultrasonic parameters are controlled to form a standing wave field, the ultrasonic mechanical effect drives dispersed water droplets to migrate toward pressure nodal regions, forming a band-like distribution of water droplets, shortening the distance between water droplets, and promoting coalescence of water droplets; the electric field polarization effect causes oscillation of water droplets to reduce the strength of the interfacial film, and promotes directional migration and coalescence of water droplets through electrophoresis and dielectrophoresis effects that are stronger at short distances. The synergistic action of the two effects significantly improves the coalescence efficiency of dispersed water droplets, thereby accelerating the demulsification process.

### Embodiment 1

A water-in-oil emulsion was prepared at 20 °C using Triton X-100 reagent, deionized water, and dimethyl silicone oil. The Triton X-100 reagent was added at a concentration of 500 ppm, and the emulsion was prepared by stirring with an IKA-T18 disperser at 15,000 rpm for 10 min.

In the water-in-oil emulsion with a water content of 10% prepared under the above conditions, the average particle size of the dispersed phase was maintained at approximately 15 μm. Gravity settling experiments were conducted on the emulsion. The gravity settling efficiency was 0% at 15 min and only 9% at 30 min, indicating that the water-in-oil emulsion obtained by this formulation had a certain stability.

For the above water-in-oil emulsion, when demulsification was performed using only the electric field polarization effect, under the experimentally obtained optimal electric field parameters (electric field waveform: bipolar square wave, electric field frequency: 3 kHz, electric field strength: 70 kV/m), the demulsification efficiency was 55.32% at 3 min;
when demulsification was performed using only the ultrasonic cavitation effect, under the experimentally obtained optimal ultrasonic parameters (ultrasonic frequency: 27.97 kHz, ultrasonic intensity: 0.4 W/cm²), the demulsification efficiency was 32.50% at 3 min;
when demulsification was performed using only the ultrasonic mechanical effect, under the experimentally obtained optimal ultrasonic parameters (ultrasonic frequency: 126.18 kHz, ultrasonic intensity: 0.6 W/cm²), the demulsification efficiency was 46.00% at 3 min;
when synergistic demulsification was performed using the ultrasonic cavitation effect and the electric field polarization effect, under the experimentally obtained optimal ultrasonic parameters and electric field parameters (electric field waveform: bipolar square wave, electric field frequency: 3 kHz, electric field strength: 70 kV/m, ultrasonic frequency: 27.97 kHz, ultrasonic intensity: 0.3 W/cm²), the demulsification efficiency was 68.80% at 3 min; and
when synergistic demulsification was performed using the ultrasonic mechanical effect and the electric field polarization effect, under the experimentally obtained optimal ultrasonic parameters and electric field parameters (electric field waveform: bipolar square wave, electric field frequency: 3 kHz, electric field strength: 70 kV/m, ultrasonic frequency: 126.18 kHz, ultrasonic intensity: 0.6 W/cm²), the demulsification efficiency was 76.50% at 3 min.

Through comparative analysis, the method provided in this example exhibits a better demulsification effect.

### Embodiment 2

For the above water-in-oil emulsion, when demulsification was performed using only the electric field polarization effect, under the experimentally obtained optimal electric field parameters (electric field waveform: bipolar square wave, electric field frequency: 3 kHz, electric field strength: 70 kV/m), the demulsification efficiency was 55.32% at 3 min;
when demulsification was performed using only the ultrasonic cavitation effect, under the experimentally obtained optimal ultrasonic parameters (ultrasonic frequency: 27.97 kHz, ultrasonic intensity: 0.5 W/cm²), the demulsification efficiency was 33.00% at 3 min;
when demulsification was performed using only the ultrasonic mechanical effect, under the experimentally obtained optimal ultrasonic parameters (ultrasonic frequency: 126.18 kHz, ultrasonic intensity: 0.6 W/cm²), the demulsification efficiency was 42.67% at 3 min;
when synergistic demulsification was performed using the ultrasonic cavitation effect and the electric field polarization effect, under the experimentally obtained optimal ultrasonic parameters and electric field parameters (electric field waveform: bipolar square wave, electric field frequency: 3 kHz, electric field strength: 70 kV/m, ultrasonic frequency: 27.97 kHz, ultrasonic intensity: 0.4 W/cm²), the demulsification efficiency was 70.00% at 3 min; and
when synergistic demulsification was performed using the ultrasonic mechanical effect and the electric field polarization effect, under the experimentally obtained optimal ultrasonic parameters and electric field parameters (electric field waveform: bipolar square wave, electric field frequency: 3 kHz, electric field strength: 70 kV/m, ultrasonic frequency: 126.18 kHz, ultrasonic intensity: 0.6 W/cm²), the demulsification efficiency was 76.87% at 3 min.

Through comparative analysis, the method provided in this example exhibits a better demulsification effect.

### EXAMPLE 2

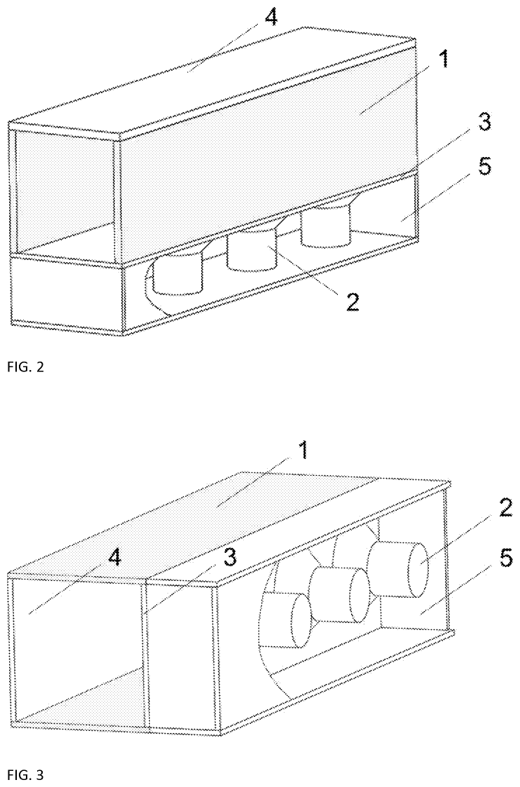

In a typical embodiment of this disclosure, an ultrasonic-electric field coupled demulsification module is provided, as shown in FIGS. 2 to 5, including at least one ultrasonic-electric field coupled demulsification unit, the unit including electrode plates 1, a transducer 2, an acoustic matching plate 3, an acoustic reflector plate 4, and a protective housing 5, where the electrode plates 1, the acoustic matching plate 3, and the acoustic reflector plate 4 enclose a flow channel; the electrode plates 1 are arranged in opposing pairs; the acoustic matching plate 3 and the acoustic reflector plate 4 are arranged opposite each other; the transducer 2 is located outside the flow channel and installed on the acoustic matching plate 3; the protective housing 5 is disposed outside the transducer 2; the electrode plates 1 are configured to apply an electric field to an emulsion within the flow channel; the transducer 2 is configured to apply an ultrasonic field to the emulsion within the flow channel; and the electric field and the ultrasonic field are used to perform synergistic demulsification on the emulsion within the flow channel.

In this example, the acoustic reflector plate 4 is configured to reflect ultrasonic waves to assist in generating an ultrasonic standing wave field; the acoustic matching plate 3 is configured to optimize energy transmission of the ultrasonic waves from the transducer 2, reducing an acoustic impedance difference between the transducer 2 and a treatment medium, thereby reducing propagation energy loss and improving ultrasonic energy transmission efficiency. The protective housing 5 is disposed around the transducer 2 to prevent the emulsion from entering the transducer region.

Optionally, the electrode plates 1 are arranged vertically opposite each other, and the acoustic matching plate 3 and the acoustic reflector plate 4 are arranged horizontally opposite each other, as shown in FIG. 2.

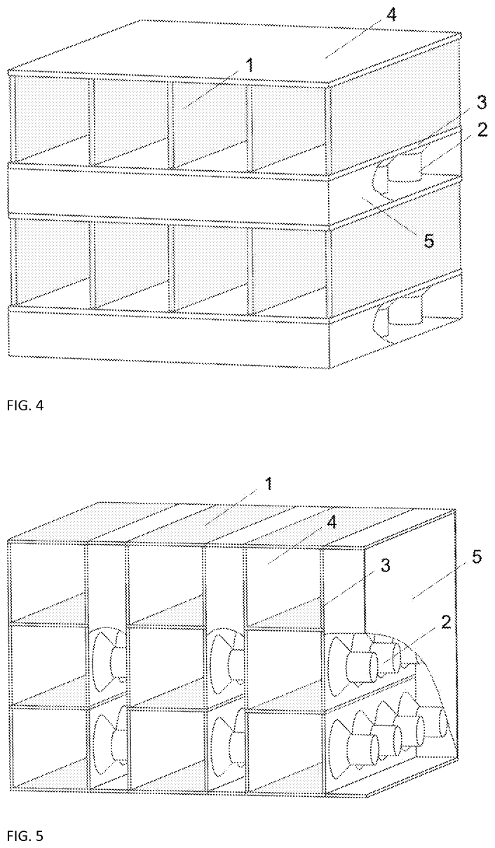

Optionally, the electrode plates 1 are arranged horizontally opposite each other, and the acoustic matching plate 3 and the acoustic reflector plate 4 are arranged vertically opposite each other, as shown in FIG. 3.

Optionally, when an ultrasonic mechanical effect is used, a distance between the acoustic matching plate 3 and the acoustic reflector plate 4 is an integer multiple of half a wavelength of ultrasound in the emulsion.

In this example, one or more transducers 2 may be installed on the acoustic matching plate 3, and the transducers 2 may share the protective housing 5 for protection, as shown in FIGS. 2 and 3.

In this example, adjacent ultrasonic-electric field coupled demulsification units in the ultrasonic-electric field coupled demulsification module may share the electrode plates 1, and the electrode plates 1 are arranged in an alternating pattern of high-voltage electrode plates and low-voltage electrode plates, as shown in FIGS. 4 and 5.

### EXAMPLE 3

In a typical embodiment of this disclosure, a separation apparatus is provided, including the ultrasonic-electric field coupled demulsification module of Example 2, where the ultrasonic-electric field coupled demulsification module is arranged in an emulsion layer region thereof according to cross-sectional characteristics of the separation apparatus, and a flow channel direction within the ultrasonic-electric field coupled demulsification module is consistent with a flow direction of an emulsion in the separation apparatus.

Optionally, the ultrasonic-electric field coupled demulsification module adjusts ultrasonic parameters and electric field parameters according to characteristics of emulsions in different cross-sectional regions of the separation apparatus.

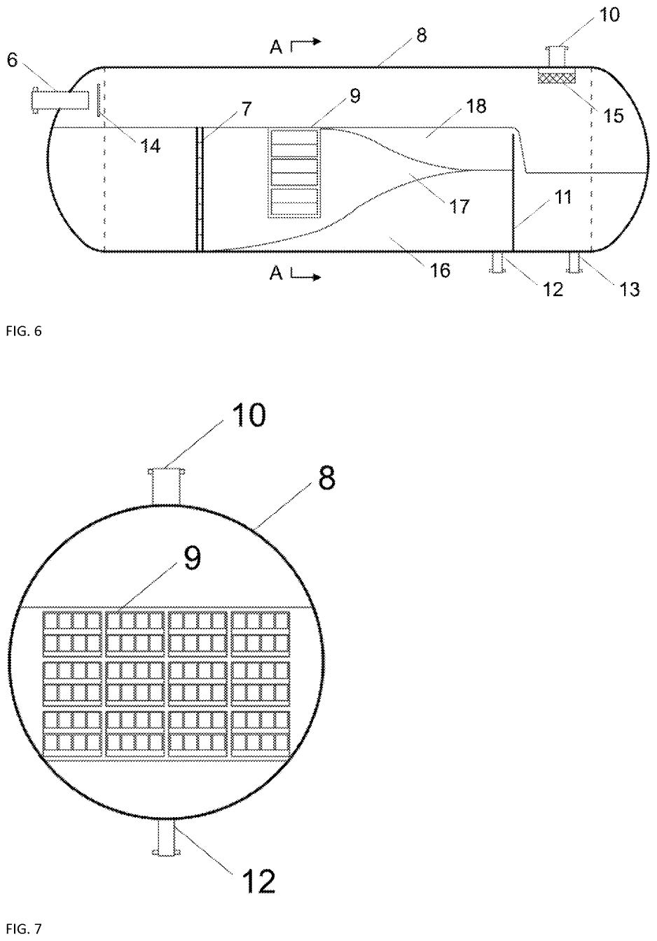

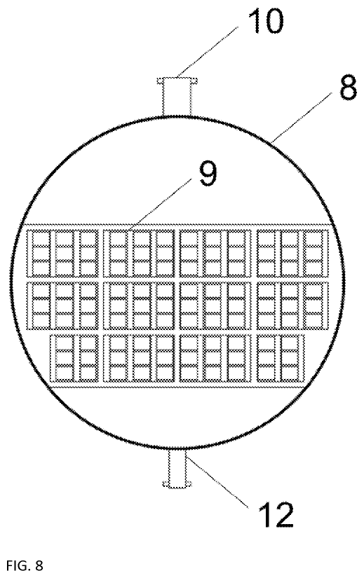

As shown in FIGS. 6 to 8, the separation apparatus includes a separator cylinder 8, and the ultrasonic-electric field coupled demulsification module 9 is disposed within the separator cylinder 8. The ultrasonic-electric field coupled demulsification module 9 is installed in the emulsion layer 17 position behind a flow-straightening plate 7 inside the separator cylinder 8; the separator cylinder 8 is of a horizontal type, and the flow-straightening plate 7 and a weir plate 11 are disposed inside the separator cylinder 8; the flow-straightening plate 7 and the weir plate 11 are arranged in parallel and spaced apart by a set distance, and the ultrasonic-electric field coupled demulsification module 9 is disposed between the flow-straightening plate 7 and the weir plate 11 and close to the flow-straightening plate 7.

Further, the separator cylinder 8 is provided with a separator inlet 6, a gas outlet 10, a water outlet 12, and an oil outlet 13, where the separator inlet 6 is located at one end of the separator cylinder 8, the gas outlet 10 is located at the top of the other end of the separator cylinder 8, the oil outlet 13 is located at the bottom of the other end of the separator cylinder 8, and the water outlet 12 is located at the bottom of the separator cylinder 8 between the flow-straightening plate 7 and the weir plate 11 and close to the weir plate 11.

Further, an inlet distributor 14 is arranged at the separator inlet 6, and a mist eliminator 15 is arranged at the gas outlet 10.

The working principle of the separation apparatus equipped with the ultrasonic-electric field coupled demulsification module is as follows:
an oilfield produced fluid enters the separation apparatus through the separator inlet 6 via the inlet distributor 14; most of the gas is separated at the inlet distributor 14, passes through the mist eliminator 15 for mist removal, and is discharged through the gas outlet 10; meanwhile, the oil-water emulsion falls from the inlet distributor 14 to the liquid layer, flows through the flow-straightening plate 7 to form a stable flow, and enters the ultrasonic-electric field coupled demulsification module 9; after demulsification by this module, the emulsion layer 17 gradually separates into an oil layer 18 and a water layer 16. The separated oil layer 18 flows over the weir plate 11 into an oil compartment and is discharged through the oil outlet 13, while the separated water layer 16 is discharged through the water outlet 12.

Further, by adjusting ultrasonic parameters and electric field parameters, the ultrasonic cavitation effect and the electric field polarization effect are used to synergistically demulsify the emulsion. Specifically, the ultrasonic-electric field coupled demulsification module sets the ultrasonic parameters within the steady cavitation effect range to avoid breakup of water droplets caused by transient cavitation; by setting the electric field parameters within the effective electrocoalescence range of water droplets in the emulsion, excessively strong electric fields that may lead to non-coalescence and breakup of water droplets are prevented; and
the ultrasonic steady cavitation effect generates periodically oscillating bubbles that cause water droplets to oscillate and weaken the stability of the interfacial film, while the oscillation of the water droplets accelerates the coalescence of adjacent water droplets; the electric field polarization effect enhances the oscillation of the water droplets to further reduce the strength of the interfacial film and promote directional migration and coalescence of the water droplets through electrophoresis and dielectrophoresis effects. The synergistic demulsification through the two effects can effectively improve the coalescence efficiency of water droplets, thereby accelerating the demulsification process.

Optionally, by adjusting ultrasonic parameters and electric field parameters, the ultrasonic mechanical effect and the electric field polarization effect are used to synergistically demulsify the emulsion. Specifically, the ultrasonic-electric field coupled demulsification module sets the ultrasonic parameters to form a standing wave field; by setting the electric field parameters within the effective electrocoalescence range of water droplets in the emulsion, excessively strong electric fields that may lead to non-coalescence and breakup of water droplets are prevented; and
under the action of the standing wave field, the ultrasonic mechanical effect drives dispersed water droplets to migrate toward pressure nodal regions, forming a band-like distribution of water droplets, shortening the distance between water droplets, and promoting coalescence of water droplets; the electric field polarization effect causes oscillation of water droplets to reduce the strength of the interfacial film, and promotes directional migration and coalescence of water droplets through electrophoresis and dielectrophoresis effects that are stronger at short distances. The synergistic demulsification through the two effects can significantly improve the coalescence efficiency of dispersed water droplets, thereby accelerating the demulsification process.

Further, a section between the flow-straightening plate 7 in the separator and the ultrasonic-electric field coupled demulsification module 9 serves as a settling section to allow the emulsion to flow horizontally and achieve a certain degree of separation under gravity before entering the ultrasonic-electric field coupled demulsification module 9. At this stage, the water content of the emulsion varies vertically; more specifically, the size and packing density of water droplets in the emulsion differ at different heights. The higher the position, the fewer the number of water droplets and the smaller the size. Therefore, modules at different heights can achieve efficient demulsification by applying different electric field parameters and ultrasonic field parameters, while also preventing excessively high local parameter values, which could cause breakup of water droplets and instead intensify emulsification. The regulation principle can be based on the water content at different heights, which can be obtained through experiments.

Although the embodiments of this disclosure have been described above in conjunction with the accompanying drawings, they are not intended to limit the scope of protection of this disclosure. Those skilled in the art should understand that, based on the technical solutions of this disclosure, various modifications or variations made by those skilled in the art without making creative efforts still fall within the scope of protection of this disclosure.

1. An ultrasonic-electric field coupled demulsification method, comprising the following steps:
S1: applying both an ultrasonic field and an electric field to a to-be-treated emulsion within the same region;
S2: adjusting ultrasonic parameters to a range that generates a steady cavitation effect in the emulsion, while adjusting electric field parameters to a range that promotes effective electrocoalescence of water droplets in the emulsion, thereby performing synergistic demulsification on the emulsion using the ultrasonic cavitation effect and an electric field polarization effect;
or, adjusting ultrasonic parameters to a range that forms a standing wave field in the emulsion, while adjusting electric field parameters to a range that promotes effective electrocoalescence of water droplets in the emulsion, thereby performing synergistic demulsification on the emulsion using an ultrasonic mechanical effect and an electric field polarization effect; and
S3: performing oil-water separation on the emulsion demulsified in S2.

2. The ultrasonic-electric field coupled demulsification method of claim 1, wherein the ultrasonic field and the electric field are arranged perpendicularly.

3. An ultrasonic-electric field coupled demulsification module, configured to implement the demulsification method of claim 1, comprising at least one ultrasonic-electric field coupled demulsification unit, the unit comprising electrode plates, a transducer, an acoustic matching plate, an acoustic reflector plate, and a protective housing, wherein the electrode plates, the acoustic matching plate, and the acoustic reflector plate enclose a flow channel; the electrode plates are arranged in opposing pairs; the acoustic matching plate and the acoustic reflector plate are arranged opposite each other; the transducer is located outside the flow channel and installed on the acoustic matching plate; the protective housing is disposed outside the transducer; the electrode plates are configured to apply an electric field to an emulsion within the flow channel; the transducer is configured to apply an ultrasonic field to the emulsion within the flow channel; and the electric field and the ultrasonic field are used to perform synergistic demulsification on the emulsion within the flow channel.

4. The ultrasonic-electric field coupled demulsification module of claim 3, wherein the electrode plates are arranged vertically opposite each other, and the acoustic matching plate and the acoustic reflector plate are arranged horizontally opposite each other.

5. The ultrasonic-electric field coupled demulsification module of claim 3, wherein the electrode plates are arranged horizontally opposite each other, and the acoustic matching plate and the acoustic reflector plate are arranged vertically opposite each other.

6. The ultrasonic-electric field coupled demulsification module of claim 3, wherein when an ultrasonic mechanical effect is used, a distance between the acoustic matching plate and the acoustic reflector plate is an integer multiple of half a wavelength of ultrasound in the emulsion.

7. The ultrasonic-electric field coupled demulsification module of claim 3, wherein at least one transducer is installed on the acoustic matching plate, and the transducer can share the protective housing for protection.

8. The ultrasonic-electric field coupled demulsification module of claim 3, wherein when a plurality of ultrasonic-electric field coupled demulsification units are arranged, adjacent ultrasonic-electric field coupled demulsification units can share the electrode plates, and the electrode plates are arranged in an alternating pattern of high-voltage electrode plates and low-voltage electrode plates.

9. A separation apparatus, comprising the ultrasonic-electric field coupled demulsification module of claim 3, wherein the ultrasonic-electric field coupled demulsification module is arranged in an emulsion layer region thereof according to cross-sectional characteristics of the separation apparatus, and a flow channel direction within the ultrasonic-electric field coupled demulsification module is consistent with a flow direction of an emulsion in the separation apparatus.

10. The separation apparatus of claim 9, wherein the ultrasonic-electric field coupled demulsification module adjusts ultrasonic parameters and electric field parameters according to characteristics of emulsions in different cross-sectional regions of the separation apparatus.
